(19) United States
(12) Patent Application Publication
(10) Pub. No.: US 2023/0239716 A1
(43) Pub. Date: Jul. 27, 2023

(54) NETWORK OPERATION IN CHANGING PHYSICAL ENVIRONMENTS

(71) Applicant: Telefonaktiebolaget LM Ericsson (publ), Stockholm (SE)

(72) Inventors: Osman Nuri Can YILMAZ, HELSINKI (FI); Anna LARMO, ESPOO (FI); Fedor CHERNOGOROV, ESPOO Uusimaa (FI); Johan TORSNER, KYRKSLÄTT (FI)

(21) Appl. No.: 18/013,516

(22) PCT Filed: Jun. 30, 2020
(86) PCT No.: PCT/SE2020/050682

§ 371 Date: Dec. 28, 2022

(51) Int. Cl. H04W 24/10; H04W 24/06

(52) U.S. Cl. CPC H04W 24/10; H04W 24/06

(57) ABSTRACT

There is provided mechanisms for handling a change in a physical environment in which a network provides service. A method includes obtaining an indication of change in the physical environment. The method includes performing an action when the indication fulfils a condition. The action pertains to at least one of obtaining radio measurements from network equipment operating in the network, providing radio measurement configuration to the network equipment, providing network configuration to the network equipment.

### TECHNICAL FIELD

Embodiments presented herein relate to a method, a network management entity, a computer program, and a computer program product for handling a change in a physical environment in which a network provides service.

### BACKGROUND

In communications networks, there may be a challenge to obtain good performance and capacity for a given communications protocol, its parameters and the physical environment in which the communications network is deployed.

As an illustrative example, wireless communications networks deployed in industrial environments might have strict requirements on the wireless system performance. Some applications might require very low latency and high reliability. This is sometimes referred to as Ultra Reliable Low Latency Communication (URLLC). Some applications might not have such strict latency requirements but instead require constant network availability, for example when the application is a control application that constantly needs access to resources in the communications network.

Careful network planning might therefore be needed for some communications networks, such as wireless communication networks deployed in industrial environments and aimed at providing network access to network equipment operating in the industrial environment, to ensure the required network quality of service to sustain the envisioned services. Such network planning might be complemented with actual on-site measurements from the network equipment. In this respect, a digital representation, also known as a digital twin, of the network might be created. Simulations and tests might then be performed using the digital representation of the network, e.g. using collected measurements from the deployed network before any reconfiguration is made to the deployed network.

In some scenarios the physical environment in which the communication network is deployed is changing over time. One non-limiting example of such a physical environment is a port site where large containers are moved around the site. Such changes might completely change the radio propagation conditions of the wireless communication network. Other non-limiting examples are mine sites and construction sites where the physical environment gradually changes over time as material is moved from one place to another (or removed from the site). Yet another non-limiting example is industrial sites, such as factories, where the physical environment changes as new equipment is installed or large metal objects are moved.

As a result thereof, the radio propagation conditions might thus change and it might be challenging to know if requirements on, e.g., latency, reliability, and/or bitrate will be possible to maintain for critical services. Even if significant effort is put in measuring the radio propagation conditions as such, or the resulting latency, reliability, and/or bitrate, at different locations in the physical environment where the communication network is installed, the radio propagation conditions might change over time. In some scenarios it might not be desirable to continuously perform measurements to check if the radio propagations conditions have changed. One reason for this could be that extra radio resources might be needed to make the measurements. Another reason is that in some cases specialized measurement devices might be needed to make accurate measurements, e.g., along possible routes for automated guided vehicles (AGVs) or autonomous vehicles.

Hence, there is still a need for efficient operation of networks deployed in physical environment that change over time.

### SUMMARY

An object of embodiments herein is to provide mechanisms that enable efficient operation of networks deployed in physical environments that change over time.

According to a first aspect there is presented a method for handling a change in a physical environment in which a network provides service. The method comprises obtaining an indication of change in the physical environment. The method comprises performing an action when the indication fulfils a condition. The action pertains to at least one of obtaining radio measurements from network equipment operating in the network, providing radio measurement configuration to the network equipment, providing network configuration to the network equipment.

According to a second aspect there is presented a network management entity for handling a change in a physical environment in which a network provides service. The network management entity comprises processing circuitry. The processing circuitry is configured to cause the network management entity to obtain an indication of change in the physical environment. The processing circuitry is configured to cause the network management entity to perform an action when the indication fulfils a condition. The action pertains to at least one of obtaining radio measurements from network equipment operating in the network, providing radio measurement configuration to the network equipment, providing network configuration to the network equipment.

According to a third aspect there is presented a network management entity for handling a change in a physical environment in which a network provides service. The network management entity comprises an obtain module configured to obtain an indication of change in the physical environment. The network management entity comprises an action module configured to perform an action when the indication fulfils a condition. The action pertains to at least one of obtaining radio measurements from network equipment operating in the network, providing radio measurement configuration to the network equipment, providing network configuration to the network equipment.

According to a fourth aspect there is presented a computer program for handling a change in a physical environment in which a network provides service, the computer program comprising computer program code which, when run on a network management entity, causes the network management entity 200 to perform a method according to the first aspect.

According to a fifth aspect there is presented a computer program product comprising a computer program according to the fourth aspect and a computer readable storage medium on which the computer program is stored. The computer readable storage medium could be a non-transitory computer readable storage medium.

Advantageously, these aspects enable efficient operation of networks deployed in physical environment that change over time.

Advantageously, these aspects enable network conditions to be monitored in an efficient way.

Advantageously, this in turn ensures reliable operation and saves network resources and capacity. Advantageously, this can be achieved by, e.g., performing new radio measurements, sending measurement reports, and/or configuring positioning signals or reference signals only if a significant change in the physical environment is detected.

Advantageously, depending on the indicated change in the physical environment, the necessary actions to ensure the right level of communication service quality can be taken.

Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, module, step, etc.” are to be interpreted openly as referring to at least one instance of the element, apparatus, component, means, module, step, etc., unless explicitly stated otherwise.

The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIG. 1 is a schematic diagram illustrating a physical environment in which a network provides service according to embodiments;

FIGS. 2 and 3 are flowcharts of methods according to embodiments;

FIG. 4 is a signalling diagram of a method according to an embodiment;

FIG. 5 is a schematic diagram showing functional units of a network management entity according to an embodiment;

FIG. 6 is a schematic diagram showing functional modules of a network management entity according to an embodiment;

FIG. 7 shows one example of a computer program product comprising computer readable storage medium according to an embodiment;

FIG. 8 is a schematic diagram illustrating a telecommunication network connected via an intermediate network to a host computer in accordance with some embodiments; and

FIG. 9 is a schematic diagram illustrating host computer communicating via a radio base station with a terminal device over a partially wireless connection in accordance with some embodiments.

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

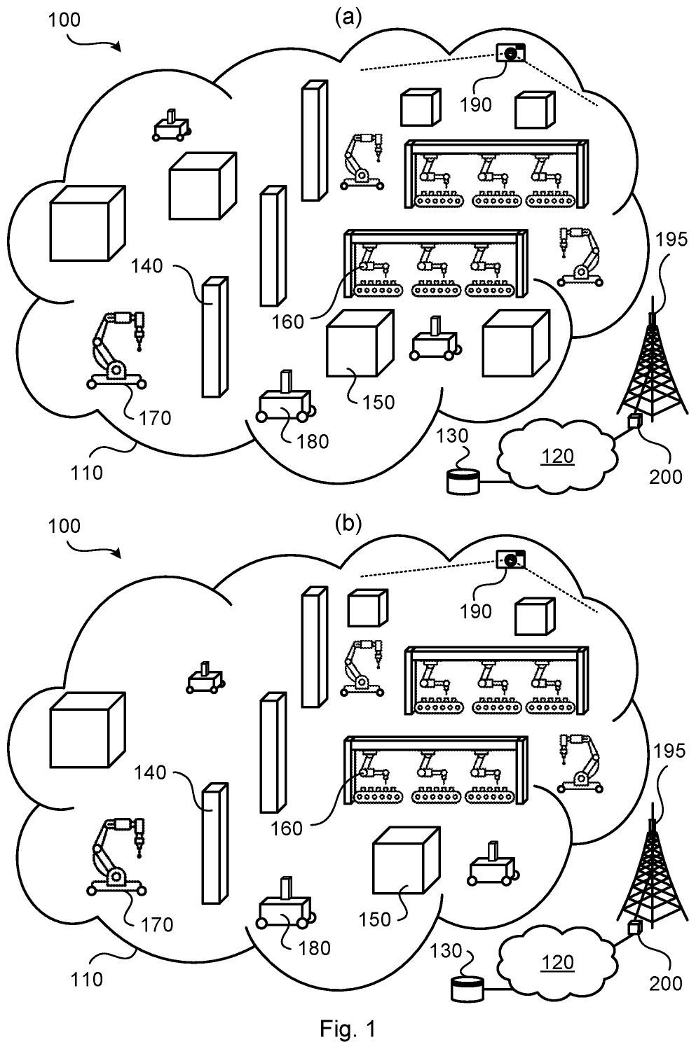

FIG. 1 is a schematic diagram illustrating physical environment 100 in which a network 110 provides service where embodiments presented herein can be applied. The network 110 could be a third generation (3G) telecommunications network, a fourth generation (4G) telecommunications network, or a fifth (5G) telecommunications network and support any 3GPP telecommunications standard, where applicable. Additionally or alternatively, the network 110 could support one or more protocols in the IEEE 802 set of local area network (LAN) protocols, such as IEEE 802.11 and its evolution. Additionally or alternatively, the network 110 could support protocols such as the long range wireless access network (LoRAWAN), ZigBee, Bluetooth, etc. Further, the network 110 could be any of: a wireless communication network, an industrial communication network, a URLLC network, an IoT network, or an industrial IoT network, or any combination thereof.

For illustrative purposes the physical environment 100 comprises stationary physical objects (one of which is identified at reference numeral 140) as well as movable physical objects (one of which is identified at reference numeral 150). Non-limiting examples of stationary physical objects 140 are buildings (including walls, ceilings, floors, etc.). Non-limiting examples of movable physical objects 150 are containers, boxes, doors, trucks and other types of vehicles.

The network 110 can be regarded as a wireless access network. In some aspects, the network 110 is served by one or more access nodes 195 (also known as a radio base station, such as a NodeB, an evolved NodeB or a gNB). The network 110 is operated, or managed, by a network management entity 200. The network management entity 200 is operatively connected to a database 130 over a core network 120.

In the physical environment 100 there could be different examples of network-connected equipment, devices, nodes, and entities. Examples of such network-connected equipment are stationary network equipment (one of which is identified at reference numeral 160, movable network equipment (one of which is identified at reference numeral 170), positioning equipment (one of which is identified at reference numeral 180, and sensors 190. Examples of network equipment 160, 170, 195 are: IoT devices, autonomous vehicles, automated guided vehicles, user equipment, access nodes, core network nodes, or any combination thereof. Hence, in some aspects, the access node 195 can also be regarded as being a network equipment. Examples of positioning equipment 180 are: dedicated positioning devices, such as GPS devices, and other types of positioning devices, such as user equipment where positioning information can be obtained by means of radio measurements, etc. Hence, user equipment might, depending on its use, be regarded as either network equipment, or positioning equipment, or combined network equipment and positioning equipment. Examples of sensors 190 are: image sensors (e.g. still image cameras or video cameras), light sensors, temperature sensors, positioning sensors, radar sensors, lidar sensors, sonic sensors (e.g. ultrasound measurement equipment), or any combination thereof. Further, the network equipment 160, 170, the positioning equipment 180, and/or the sensors 190 might be integrated within other devices, entities, nodes, or physical objects (such as the movable physical objects 150 and/or the stationary physical objects 140) or attached to the surface(s) of these devices, entities, nodes, or physical objects to enable positioning measurements by means of positioning/reference signals and detect changes in the physical environment 100 that could potentially affect radio propagation conditions.

For ease of description of this disclosure, a given piece of equipment is characterized as being one of a network equipment 160, 170, positioning equipment 180, or a sensor 190. However, it is understood that a given piece of equipment could implement the functionality of two or more of these types of equipment and thus being a combined network equipment 160, 170, positioning equipment 180, and/or sensor 190. Thus, when reference e.g. is made to a sensor 190, this should be interpreted as that reference is made to any equipment as disclosed herein at least having a sensor 190, although that equipment might further comprise, or implement, a positioning functionality and/or a network functionality. For example, an IoT device as above characterized as being a network equipment, might be provided with a positioning functionality and/or a sensor.

The movable physical objects 150 might change their location. This might in turn impact the radio propagation conditions in the network 110 and thus eventually impact the performance of the stationary network equipment 160 as well as the movable network equipment 170. FIG. 1 at (a) and (b) shows the physical environment 100 before and after a change in the location of some of the movable physical objects 150 and measurement equipment 180.

As noted above there is still a need for efficient operation of networks 110 deployed in physical environment 100 that change over time.

The embodiments disclosed herein in particular relate to mechanisms for handling a change in a physical environment 100 in which a network 110 provides service. In order to obtain such mechanisms there is provided a network management entity 200, a method performed by the network management entity 200, a computer program product comprising code, for example in the form of a computer program, that when run on a network management entity 200, causes the network management entity 200 to perform the method.

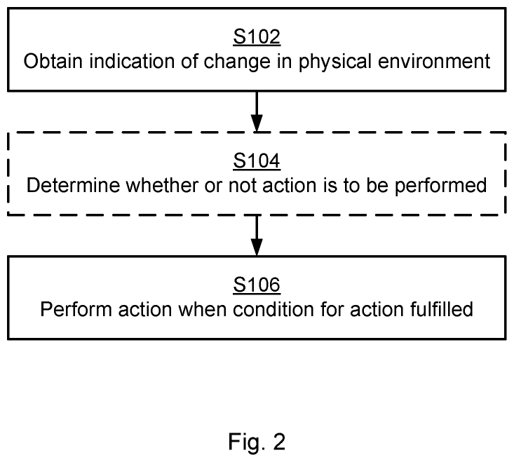

FIG. 2 is a flowchart illustrating embodiments of methods for handling a change in a physical environment 100 in which a network 110 provides service. The methods might be performed by the network management entity 200. The methods are advantageously provided as computer programs 720.

S102: An indication of change in the physical environment 100 is obtained. Examples of such indications and from where the indications might be obtained will be provided below. At least some of the herein disclosed embodiments are thus based on the fact that changes in the physical environment 100 can be detected by network equipment 160, 170, 195, positioning equipment 180, and/or sensors 190. Information from any of these sources can be used to detect that a change has occurred in the physical environment 100.

S106: An action is performed when the indication fulfills a condition. The action pertains to at least one of: obtaining radio measurements from network equipment 160, 170, 195 operating in the network 110, providing radio measurement configuration to the network equipment 160, 170, 195, providing network configuration to the network equipment 160, 170, 195. Examples of conditions, actions, radio measurement configurations, and network configuration will be provided below.

At least some of the herein disclosed embodiments are thus based on that if the change is large enough to suspect that radio conditions in the network 110 may have changed substantially, different types of actions might be triggered to verify the performance and, optionally, update the new database 130 accordingly.

Embodiments relating to further details of handling a change in a physical environment 100 in which a network 110 provides service as performed by the network management entity 200 will now be disclosed.

Aspects of the indication as obtained in step S102 will now be disclosed.

As noted above, there could be different types of indications that are obtained in step S102. In some examples, the indication of change in the physical environment 100 pertains to any of: change in lighting level at least somewhere in the physical environment 100, change in temperature at least somewhere in the physical environment 100, change in location of at least one physical object 150 in the physical environment 100, or any combination thereof. In further examples, the change in lighting level and/or the change in temperature provides an indication of that the at least one physical object 150 has changed location in the physical environment 100. In some examples, the indication is obtained from at least one sensor 190 monitoring the physical environment 100.

In some aspects, it is checked whether or not the action is to be performed by making a comparison of the indication to the condition. Hence, in some embodiments, (optional) step S104 is performed:

S104: It is determined based on comparing the indication to the condition, whether or not the action is to be performed.

Aspects of the conditions as mentioned in step S104 will now be disclosed.

As noted above, there could be different types of conditions. In some aspects, the action is performed only if a large enough change in physical environment 100 has been detected. That is, in some embodiments, the action is to be performed only when the change in the physical environment 100 is larger than a threshold value. The unit of the threshold value might depend on the condition. If the condition pertains to radio propagation parameters, then the threshold value might be specified by a decibel value. Further, the condition might relate to an estimated (or predicted, packet error rate) or estimated (or predicted) latency in the network 110 with an associated threshold value, for examples as specified by quality requirements specified in a service level agreement for the network 110.

Aspects of the different types of actions as mentioned in step S104 will now be disclosed.

In some aspects, radio measurements can be used to indicate whether network configuration is needed or not. In particular, in some embodiments, based on the comparing in step S104, it is determined that radio measurements from the network equipment 160, 170, 195 in the physical environment 100 are to be obtained. The radio measurements might be obtained from the network equipment 160, 170, 195. For example, it might be determined that radio measurements are to be obtained when the change in the physical environment 100 is estimated to be large enough to affect the radio propagation conditions in the network 110.

When the radio measurements have been obtained, it might then be determined, based on the thus obtained radio measurements, whether or not network configuration is to be provided to the network equipment 160, 170, 195 operating in the network 110. The radio measurements could be related to signal strength (such as reference signal received power; RSRP), signal and/or channel quality (such as reference signal received quality; RSRQ, or channel quality indicators; CQIs), service quality (such as latency, throughput) or receiver-transmitter timing difference.

Results of measurement or key performance indicators (KPIs) derived from the measurements might be stored in the database 130. That is, the database 130 might be updated with the obtained radio measurements or resulting KPIs. As further disclosed below, the database 130 might comprise a digital representation of the network 110 and the physical environment 100 and this digital representation might be updated in accordance with the obtained radio measurements or resulting KPIs.

In some examples, sensors 180 are used to detect changes in the physical environment 100 that could potentially affect the radio propagation conditions. In some examples, information from network equipment 160, 170, 195, positioning equipment 180, and sensors 190 is utilized for detecting changes in the physical environment 100. In some examples, detection of a change in the physical environment 100 by means of one mechanism triggers the use of at least one further mechanisms in order to enhance the detected change or for verification of the detection.

There could be different examples of radio measurement configurations. In some embodiments, the radio measurement configuration pertains to at least one of: periodicity for performing radio measurements, periodicity for reporting radio measurements, type of radio measurements to be performed, locations in the physical environment 100 at which radio measurements are to be performed.

There could be different examples of network configurations. In some embodiments, the network configuration pertains to at least one of: radio resource allocation (e.g. transmitter power configuration, radio interface configuration, channel allocation, link adaptation configuration, time division duplex (TDD) pattern allocation, frequency band allocation, network node association, etc.), handover parameters, network slicing settings, antenna settings (e.g. changing tilting or azimuth angle of the access node 195).

In some aspects, the action further involves providing AGVs with reconfigured movement routes, since their operation should be handled only in the areas with a guaranteed service level.

In some aspects, the action further involves receiving positioning measurements and/or performing positioning measurement configuration. That is, in some embodiments, the indication of change in the physical environment 100 is provided by positioning measurements in the physical environment 100, and the action further pertains to at least one of: obtaining positioning measurements from positioning equipment 180 in the physical environment 100, providing positioning measurement configuration to the positioning equipment 180. In some examples, DownLink Positioning Reference Signals (DL PRS) are utilized for positioning measurements. Additionally or alternatively, UpLink Sounding Reference Signal (UL SRS) might be used for positioning purposes. In case of downlink signal measurements, measurement values and DL PRS resource ID/beam ID might be reported. Furthermore, reception-transmission timing differences can also be used as positioning measurements. Based on the positioning measurements, a positioning method/protocol can be applied to detect the position in the physical environment 100 where the change occurred.

There could be different examples of positioning measurement configurations. In some embodiments, the positioning measurement configuration pertains to at least one of: periodicity for performing positioning measurements, periodicity for reporting positioning measurements, type of positioning measurements to be performed, locations in the physical environment 100 at which positioning measurements are to be performed. In some examples, the detection of the significant change may trigger at least one of the following: configuring more/new reference/positioning signals, decreasing reference/positioning signal periodicity for positioning measurements, increasing measurement/reporting frequency.

In some embodiments, whether or not the action is to be performed is determined also based on information available in the database 130. In some examples the database 130 comprises a digital representation of the network 110 and the physical environment 100 for simulating network behavior of the network 110 in the physical environment 100. In some embodiments, based on the comparing in step S104, it is determined that radio measurements from the network equipment 160, 170, 195 in the physical environment 100 are not to be obtained when radio measurements for the change in the physical environment 100 are already available in the database 130. Further, performance of the network configuration might be confirmed using the digital representation of the physical environment 100 before the network configuration is provided to the network equipment 160, 170, 195 operating in the network 110. Thereby, any action considered to be performed, for example to ensure sufficient level of service quality in the network 110, can first be tested in the digital twin by means of simulation, and changes might then only be applied when the simulation predicts a favorable outcome due to the planned changes.

The action might be performed either in the whole service area of the network 110 or only in an area surrounding the place for which a physical change was detected. That is, in some embodiments, the network 110 provides service in a service area of the physical environment 100, and, based on the comparing in step S104, it is determined whether to perform the action for the whole service area or only a part of the service area as identified from the change in the physical environment 100. This part of the service area might thus correspond to a location where the change in physical environment 100 occurred. For example, some of the network equipment 160, 170, and/or the positioning equipment 180 might be steered to the area where the physical change occurred to make measurement around the area of interest.

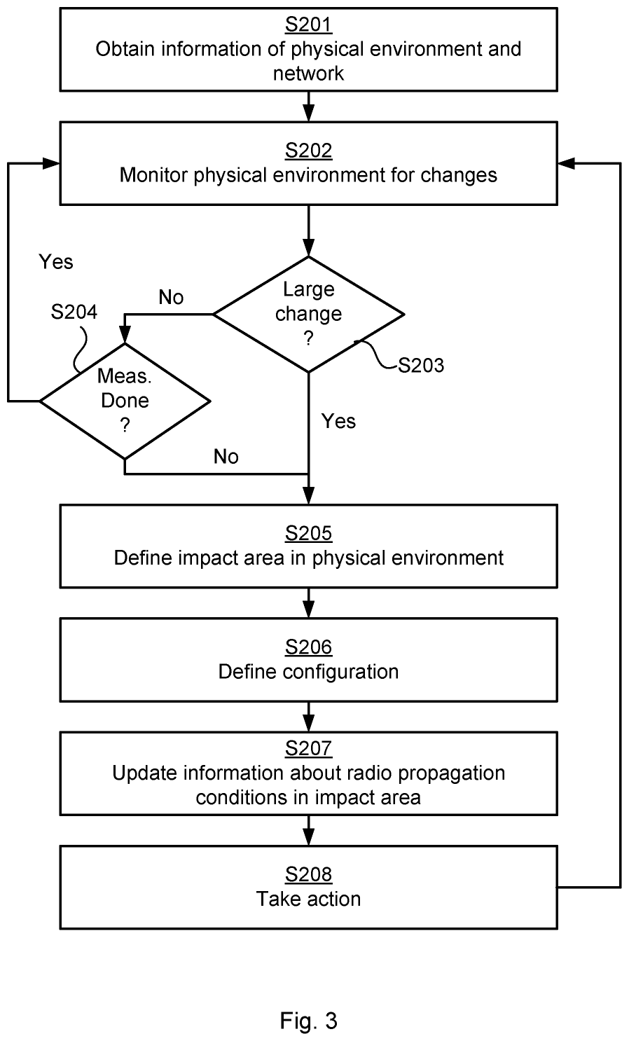

FIG. 3 is a flowchart illustrating embodiments of a method for handling a change in a physical environment 100 in which a network 110 provides service based on at least some of the above disclosed embodiments, aspects, and examples.

S201: Information of the physical environment 100 and the network 110 is obtained. The information could pertain to a facility plan of the physical environment 100, a network deployment plan of the network 110. The information could further pertain to positions of entities (such as physical objects 140, 150, network equipment 160, 170, 195, positioning equipment 180 and/or sensors 190) located in the physical environment 100.

S202: The physical environment 100 is monitored for changes. Input from any of the network equipment 160, 170, 195, positioning equipment 180 and/or sensors 190 might be used for this purpose.

S203: It is determined whether a determined change in the physical environment is larger than a threshold or not. If yes, step S205 is entered and else step S204 is entered.

S204: A check is made whether or not radio measurements and/or positioning measurements have already been performed. If yes, step S202 is entered and else step S205 is entered.

S205: An impact area surrounding the position for which the physical change in the physical environment 100 was detected is defined.

S206: Network configuration and/or positioning measurement configuration is determined for the thus defined impact area (or the whole coverage area of the network 110). Different types of such configuration have been disclosed above and apply also here.

S207: Information about the radio propagation conditions in the service area affected by the thus performed network configuration and/or positioning measurement configuration is then updated and (optionally) stored in the database 130.

S208: An action is taken to deploy the thus determined network configuration and/or positioning measurement configuration, and/or to send commands to the network equipment 160, 170, 195, positioning equipment 180 and/or sensors 190. Step S202 can then be entered again.

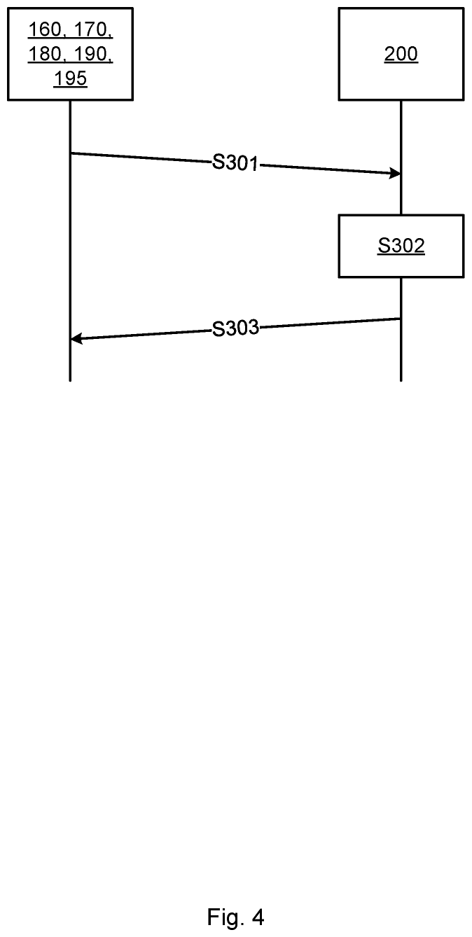

FIG. 4 is a signalling diagram of an embodiment of a method for handling a change in a physical environment 100 in which a network 110 provides service based on at least some of the above disclosed embodiments, aspects, and examples.

S301: Input from any of the network equipment 160, 170, 195, positioning equipment 180 and/or sensors 190 of a change in the physical environment 100 is provided to the network management entity 200.

S302: The network management entity 200 determines, based on comparing the indication to a condition, whether or not an action is to be performed, as in above step S104.

S303: The network management entity 200, when a condition for the action is fulfilled, performs the action and sends corresponding instructions to the network equipment 160, 170, 195, positioning equipment 180 and/or sensors 190.

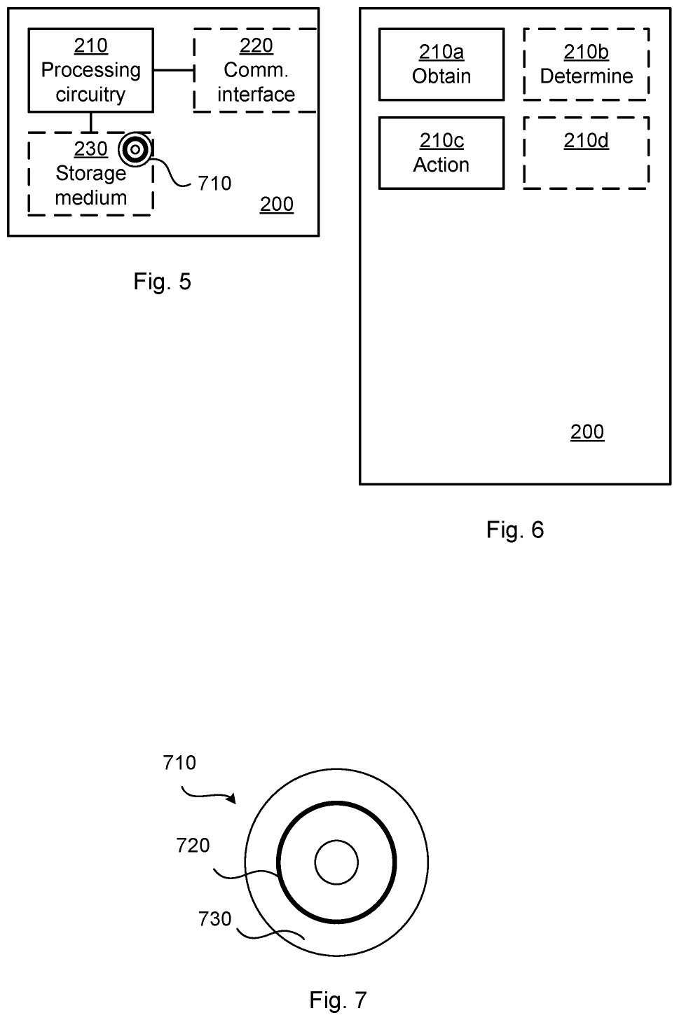

FIG. 5 schematically illustrates, in terms of a number of functional units, the components of a network management entity 200 according to an embodiment. Processing circuitry 210 is provided using any combination of one or more of a suitable central processing unit (CPU), multiprocessor, microcontroller, digital signal processor (DSP), etc., capable of executing software instructions stored in a computer program product 710 (as in FIG. 7), e.g. in the form of a storage medium 230. The processing circuitry 210 may further be provided as at least one application specific integrated circuit (ASIC), or field programmable gate array (FPGA).

Particularly, the processing circuitry 210 is configured to cause the network management entity 200 to perform a set of operations, or steps, as disclosed above. For example, the storage medium 230 may store the set of operations, and the processing circuitry 210 may be configured to retrieve the set of operations from the storage medium 230 to cause the network management entity 200 to perform the set of operations. The set of operations may be provided as a set of executable instructions.

Thus the processing circuitry 210 is thereby arranged to execute methods as herein disclosed. The storage medium 230 may also comprise persistent storage, which, for example, can be any single one or combination of magnetic memory, optical memory, solid state memory or even remotely mounted memory. The network management entity 200 may further comprise a communications interface 220 at least configured for communications with other entities, nodes, functions, devices, and equipment in the network 100. As such the communications interface 220 may comprise one or more transmitters and receivers, comprising analogue and digital components. The processing circuitry 210 controls the general operation of the network management entity 200 e.g. by sending data and control signals to the communications interface 220 and the storage medium 230, by receiving data and reports from the communications interface 220, and by retrieving data and instructions from the storage medium 230. Other components, as well as the related functionality, of the network management entity 200 are omitted in order not to obscure the concepts presented herein.

FIG. 6 schematically illustrates, in terms of a number of functional modules, the components of a network management entity 200 according to an embodiment. The network management entity 200 of FIG. 6 comprises a number of functional modules;

an obtain module 210a configured to perform step S102, and an action module 210C configured to perform step S106. The network management entity 200 of FIG. 6 may further comprise a number of optional functional modules, such as a determine module 210b configured to perform step S104, and further functional modules as represented by functional module 210d. In general terms, each functional module 210a-210d may in one embodiment be implemented only in hardware and in another embodiment with the help of software, i.e., the latter embodiment having computer program instructions stored on the storage medium 230 which when run on the processing circuitry makes the network management entity 200 perform the corresponding steps mentioned above in conjunction with FIG. 6. It should also be mentioned that even though the modules correspond to parts of a computer program, they do not need to be separate modules therein, but the way in which they are implemented in software is dependent on the programming language used. Preferably, one or more or all functional modules 210a-210d may be implemented by the processing circuitry 210, possibly in cooperation with the communications interface 220 and/or the storage medium 230. The processing circuitry 210 may thus be configured to from the storage medium 230 fetch instructions as provided by a functional module 210a-210d and to execute these instructions, thereby performing any steps as disclosed herein.

The network management entity 200 may be provided as a standalone device or as a part of at least one further device. For example, the network management entity 200 may be provided in a node of a (radio) access network or in a node of the core network. For example, the network management entity 200 might be part of, integrated with, or collocated with, the access node 195. Alternatively, functionality of the network management entity 200 may be distributed between at least two devices, or nodes. These at least two nodes, or devices, may either be part of the same network part (such as the (radio) access network or the core network) or may be spread between at least two such network parts. In general terms, instructions that are required to be performed in real time may be performed in a device, or node, operatively closer to the cell than instructions that are not required to be performed in real time.

Thus, a first portion of the instructions performed by the network management entity 200 may be executed in a first device, and a second portion of the of the instructions performed by the network management entity 200 may be executed in a second device; the herein disclosed embodiments are not limited to any particular number of devices on which the instructions performed by the network management entity 200 may be executed. Hence, the methods according to the herein disclosed embodiments are suitable to be performed by a network management entity 200 residing in a cloud computational environment. Therefore, although a single processing circuitry 210 is illustrated in FIG. 5 the processing circuitry 210 may be distributed among a plurality of devices, or nodes. The same applies to the functional modules 210a-210d of FIG. 6 and the computer program 720 of FIG. 7.

FIG. 7 shows one example of a computer program product 710 comprising computer readable storage medium 730. On this computer readable storage medium 730, a computer program 720 can be stored, which computer program 720 can cause the processing circuitry 210 and thereto operatively coupled entities and devices, such as the communications interface 220 and the storage medium 230, to execute methods according to embodiments described herein. The computer program 720 and/or computer program product 710 may thus provide means for performing any steps as herein disclosed.

In the example of FIG. 7, the computer program product 710 is illustrated as an optical disc, such as a CD (compact disc) or a DVD (digital versatile disc) or a Blu-Ray disc. The computer program product 710 could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 720 is here schematically shown as a track on the depicted optical disk, the computer program 720 can be stored in any way which is suitable for the computer program product 710.

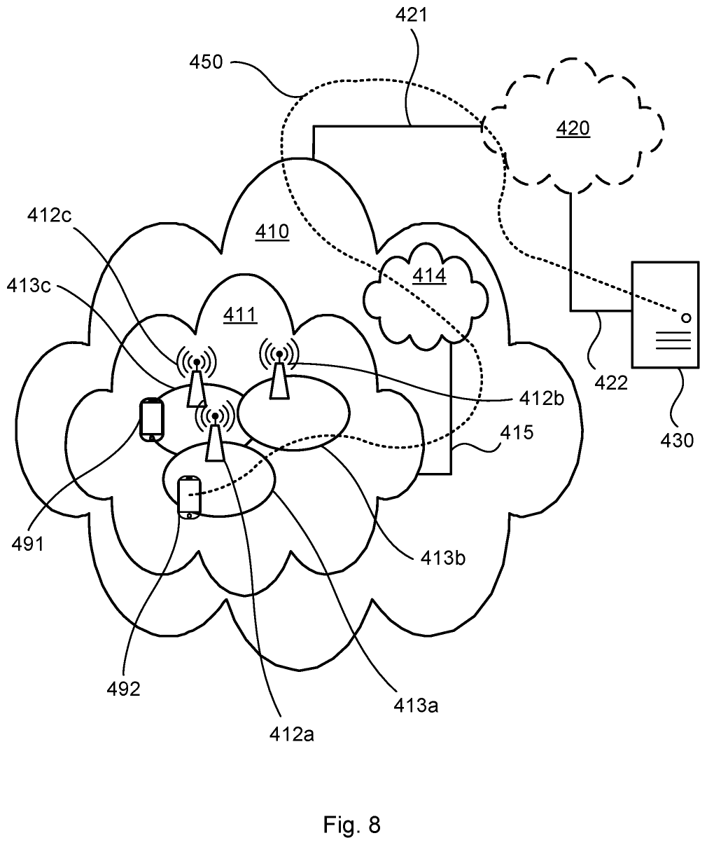

FIG. 8 is a schematic diagram illustrating a telecommunication network connected via an intermediate network 420 to a host computer 430 in accordance with some embodiments. In accordance with an embodiment, a communication system includes telecommunication network 410, such as a 3GPP-type cellular network, which comprises access network 411, such as network 110 in FIG. 1, and core network 414, such as core network 120 in FIG. 1. Access network 411 comprises a plurality of radio access network nodes 412a, 412b, 412c, such as NBs, eNBs, gNBs (each corresponding to the access node 195 of FIG. 1) or other types of wireless access points, each defining a corresponding coverage area, or cell, 413a, 413b, 413c. Each radio access network nodes 412a, 412b, 412c is connectable to core network 414 over a wired or wireless connection 415. A first UE 491 located in coverage area 413c is configured to wirelessly connect to, or be paged by, the corresponding network node 412c. A second UE 492 in coverage area 413a is wirelessly connectable to the corresponding network node 412a. While a plurality of UE 491, 492 are illustrated in this example, the disclosed embodiments are equally applicable to a situation where a sole UE is in the coverage area or where a sole terminal device is connecting to the corresponding network node 412. The UEs 491, 492 correspond to the network equipment 160, 170 of FIG. 1.

Telecommunication network 410 is itself connected to host computer 430, which may be embodied in the hardware and/or software of a standalone server, a cloud-implemented server, a distributed server or as processing resources in a server farm. Host computer 430 may be under the ownership or control of a service provider, or may be operated by the service provider or on behalf of the service provider. Connections 421 and 422 between telecommunication network 410 and host computer 430 may extend directly from core network 414 to host computer 430 or may go via an optional intermediate network 420. Intermediate network 420 may be one of, or a combination of more than one of, a public, private or hosted network; intermediate network 420, if any, may be a backbone network or the Internet; in particular, intermediate network 420 may comprise two or more sub-networks (not shown).

The communication system of FIG. 8 as a whole enables connectivity between the connected UEs 491, 492 and host computer 430. The connectivity may be described as an over-the-top (OTT) connection 450. Host computer 430 and the connected UEs 491, 492 are configured to communicate data and/or signaling via OTT connection 450, using access network 411, core network 414, any intermediate network 420 and possible further infrastructure (not shown) as intermediaries. OTT connection 450 may be transparent in the sense that the participating communication devices through which OTT connection 450 passes are unaware of routing of uplink and downlink communications. For example, network node 412 may not or need not be informed about the past routing of an incoming downlink communication with data originating from host computer 430 to be forwarded (e.g., handed over) to a connected UE 491. Similarly, network node 412 need not be aware of the future routing of an outgoing uplink communication originating from the UE 491 towards the host computer 430.

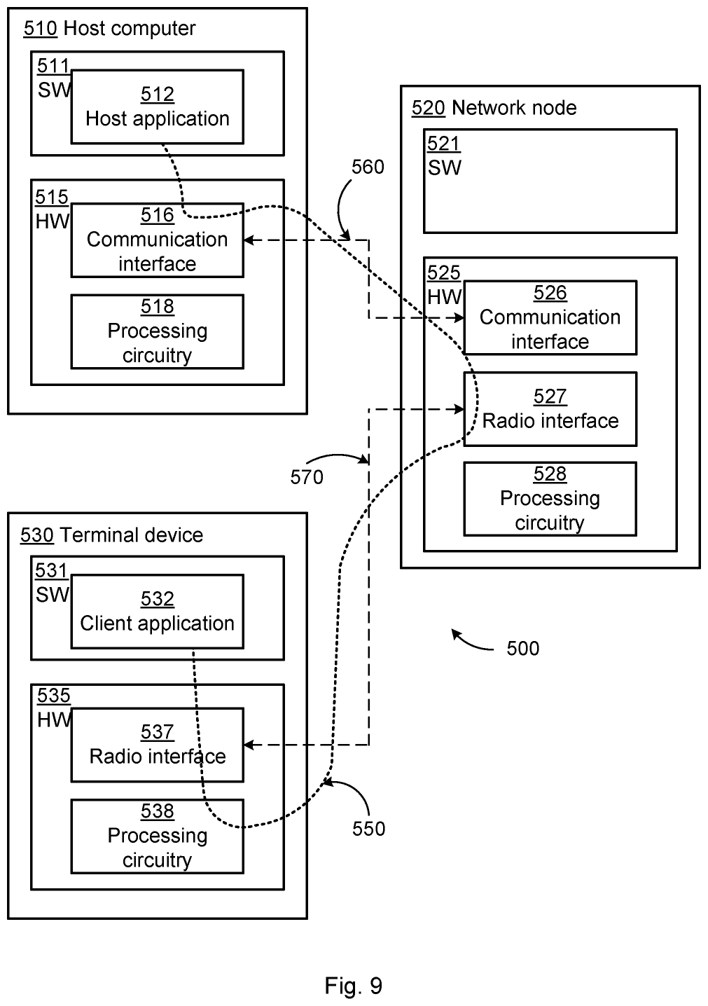

FIG. 9 is a schematic diagram illustrating host computer communicating via a radio access network node with a UE over a partially wireless connection in accordance with some embodiments. Example implementations, in accordance with an embodiment, of the UE, radio access network node and host computer discussed in the preceding paragraphs will now be described with reference to FIG. 9. In communication system 500, host computer 510 comprises hardware 515 including communication interface 516 configured to set up and maintain a wired or wireless connection with an interface of a different communication device of communication system 500. Host computer 510 further comprises processing circuitry 518, which may have storage and/or processing capabilities. In particular, processing circuitry 518 may comprise one or more programmable processors, application-specific integrated circuits, field programmable gate arrays or combinations of these (not shown) adapted to execute instructions. Host computer 510 further comprises software 511, which is stored in or accessible by host computer 510 and executable by processing circuitry 518. Software 511 includes host application 512. Host application 512 may be operable to provide a service to a remote user, such as UE 530 connecting via OTT connection 550 terminating at UE 530 and host computer 510. The UE 530 corresponds to the network equipment 160, 170 of FIG. 1. In providing the service to the remote user, host application 512 may provide user data which is transmitted using OTT connection 550.

Communication system 500 further includes radio access network node 520 provided in a telecommunication system and comprising hardware 525 enabling it to communicate with host computer 510 and with UE 530. The radio access network node 520 corresponds to the access node 195 of FIG. 1. Hardware 525 may include communication interface 526 for setting up and maintaining a wired or wireless connection with an interface of a different communication device of communication system 500, as well as radio interface 527 for setting up and maintaining at least wireless connection 570 with UE 530 located in a coverage area (not shown in FIG. 9) served by radio access network node 520. Communication interface 526 may be configured to facilitate connection 560 to host computer 510. Connection 560 may be direct or it may pass through a core network (not shown in FIG. 9) of the telecommunication system and/or through one or more intermediate networks outside the telecommunication system. In the embodiment shown, hardware 525 of radio access network node 520 further includes processing circuitry 528, which may comprise one or more programmable processors, application-specific integrated circuits, field programmable gate arrays or combinations of these (not shown) adapted to execute instructions. Radio access network node 520 further has software 521 stored internally or accessible via an external connection.

Communication system 500 further includes UE 530 already referred to. Its hardware 535 may include radio interface 537 configured to set up and maintain wireless connection 570 with a radio access network node serving a coverage area in which UE 530 is currently located. Hardware 535 of UE 530 further includes processing circuitry 538, which may comprise one or more programmable processors, application-specific integrated circuits, field programmable gate arrays or combinations of these (not shown) adapted to execute instructions. UE 530 further comprises software 531, which is stored in or accessible by UE 530 and executable by processing circuitry 538. Software 531 includes client application 532. Client application 532 may be operable to provide a service to a human or non-human user via UE 530, with the support of host computer 510. In host computer 510, an executing host application 512 may communicate with the executing client application 532 via OTT connection 550 terminating at UE 530 and host computer 510. In providing the service to the user, client application 532 may receive request data from host application 512 and provide user data in response to the request data. OTT connection 550 may transfer both the request data and the user data. Client application 532 may interact with the user to generate the user data that it provides.

It is noted that host computer 510, radio access network node 520 and UE 530 illustrated in FIG. 9 may be similar or identical to host computer 430, one of network nodes 412a, 412b, 412c and one of UEs 491, 492 of FIG. 8, respectively. This is to say, the inner workings of these entities may be as shown in FIG. 9 and independently, the surrounding network topology may be that of FIG. 8.

In FIG. 9, OTT connection 550 has been drawn abstractly to illustrate the communication between host computer 510 and UE 530 via network node 520, without explicit reference to any intermediary devices and the precise routing of messages via these devices. Network infrastructure may determine the routing, which it may be configured to hide from UE 530 or from the service provider operating host computer 510, or both. While OTT connection 550 is active, the network infrastructure may further take decisions by which it dynamically changes the routing (e.g., on the basis of load balancing consideration or reconfiguration of the network).

Wireless connection 570 between UE 530 and radio access network node 520 is in accordance with the teachings of the embodiments described throughout this disclosure. One or more of the various embodiments improve the performance of OTT services provided to UE 530 using OTT connection 550, in which wireless connection 570 forms the last segment. More precisely, the teachings of these embodiments may reduce interference, due to improved classification ability of airborne UEs which can generate significant interference.

A measurement procedure may be provided for the purpose of monitoring data rate, latency and other factors on which the one or more embodiments improve. There may further be an optional network functionality for reconfiguring OTT connection 550 between host computer 510 and UE 530, in response to variations in the measurement results. The measurement procedure and/or the network functionality for reconfiguring OTT connection 550 may be implemented in software 511 and hardware 515 of host computer 510 or in software 531 and hardware 535 of UE 530, or both. In embodiments, sensors (not shown) may be deployed in or in association with communication devices through which OTT connection 550 passes; the sensors may participate in the measurement procedure by supplying values of the monitored quantities exemplified above, or supplying values of other physical quantities from which software 511, 531 may compute or estimate the monitored quantities. The reconfiguring of OTT connection 550 may include message format, retransmission settings, preferred routing etc.; the reconfiguring need not affect network node 520, and it may be unknown or imperceptible to radio access network node 520. Such procedures and functionalities may be known and practiced in the art. In certain embodiments, measurements may involve proprietary UE signaling facilitating host computer's 510 measurements of throughput, propagation times, latency and the like. The measurements may be implemented in that software 511 and 531 causes messages to be transmitted, in particular empty or ‘dummy’ messages, using OTT connection 550 while it monitors propagation times, errors etc.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1. A method for handling a change in a physical environment in which a network provides service, the method comprising:
obtaining an indication of change in the physical environment; and
performing an action when the indication fulfils a condition, wherein the action pertains to at least one of: obtaining radio measurements from network equipment operating in the network, providing radio measurement configuration to the network equipment , providing network configuration to the network equipment.

2. The method according to claim 1, further comprising:
determining, based on comparing the indication to the condition, whether or not the action is to be performed.

3. The method according to claim 1, wherein, according to the condition, the action is to be performed only when the change in the physical environment is larger than a threshold value.

4. The method according to claim 2, wherein the network provides service in a service area of the physical environment, and wherein, based on said comparing, it is determined whether to perform the action for the whole service area or only a part of the service area as identified from the change in the physical environment.

5. The method according to claim 2, wherein whether or not the action is to be performed is determined also based on information available in a database.

6. The method according to claim 5, wherein the database comprises a digital representation of the network and the physical environment (100) for simulating network behavior of the network in the physical environment.

7. The method according to claim 5, wherein, based on said comparing, it is determined that radio measurements from network equipment in the physical environment are not to be obtained when radio measurements for the change in the physical environment are already available in the database.

8. The method according to claim 2, wherein, based on said comparing, it is determined that radio measurements from the network equipment in the physical environment are to be obtained, and wherein, when the radio measurements have been obtained, it is determined based on the radio measurements whether or not network configuration is to be provided to the network equipment operating in the network

9. (canceled)

10. The method according to claim 1, wherein the radio measurement configuration pertains to at least one of: periodicity for performing radio measurements, periodicity for reporting radio measurements, type of radio measurements to be performed, locations in the physical environment at which radio measurements are to be performed.

11. The method according to claim 1, wherein the indication of change in the physical environment is provided by positioning measurements in the physical environment, and wherein the action further pertains to at least one of: obtaining positioning measurements from positioning equipment in the physical environment, providing positioning measurement configuration to the positioning equipment

12. (canceled)

13. The method according to claim 1, wherein the network configuration pertains to at least one of: radio resource allocation, handover parameters, network slicing settings, antenna settings.

14. (canceled)

15. The method according to claim 1, wherein the indication is obtained from at least one sensor monitoring the physical environment.

16. (canceled)

17. The method according to claim 1, wherein the indication of change in the physical environment pertains to any of: change in lighting level, change in temperature, change in location of a physical object in the physical environment, or any combination thereof.

18. (canceled)

19. The method according to claim 1, wherein the method is performed by a network management entity in the network.

20. The method according to claim 1, wherein the network equipment are any of: IoT devices, autonomous vehicles, automated guided vehicles, user equipment, access nodes, core network nodes, or any combination thereof.

21. (canceled)

22. A network management entity for handling a change in a physical environment in which a network) provides service, the network management entity comprising processing circuitry, the processing circuitry being configured to cause the network management entity to:
obtain an indication of change in the physical environment; and
perform an action when the indication fulfils a condition, wherein the action pertains to at least one of: obtaining radio measurements from network equipment operating in the network, providing radio measurement configuration to the network equipment, providing network configuration to the network equipment.

23-26. (canceled)
